(19) United States
(12) Patent Application Publication
(10) Pub. No.: US 2007/0170288 A1
(43) Pub. Date: Jul. 26, 2007

(54) EXTENSION POLE WITH SWIVEL SPRAY NOZZLE AND ARTICULATED LINKAGE

(76) Inventors: Kevin Troudt, Roswell, GA (US); Andrew Thomas Molenda, Seattle, WA (US); Silakone Tet Mountha, Seattle, WA (US)

Correspondence Address: DAVID L. TINGEY;LAW OFFICE OF DAVID L. TINGEY, 15 SOUTH GRADY WAY, SUITE 336, RENTON, WA, 98057, US

(21) Appl. No.: 11/307,064

(22) Filed: Jan. 20, 2006

(51) Int. Cl. B05B 15/08

(52) U.S. Cl. 239/587.5; 239/526; 239/530; 239/532

(57) ABSTRACT

A spray nozzle mounts to an extension pole end in a swivel joint. A swivel nozzle base connects to the pole and a manifold swivelly couples the base to a swivel nozzle head such that pressurized fluid passing through the pole passes into the base, through the manifold, into the head and then out of an orifice in the head through a spray tip attached to the head at the orifice. To effect head rotation and to hold the head in a preferred orientation relative to the base, an articulated lever is attached to the head to the manifold firmly attached to the head. To move the lever on the distal end of an extension pole, it is connected to a rod that runs between the lever and an actuator on the pole. Typically, the actuator comprises a grip around the pole that slides along the pole when exercised by an operator. A spray gun is normally attached to the pole proximal end with a trigger that regulates high-pressure fluid into the pole.

### BACKGROUND

1. Field of the Invention

This invention relates to spray nozzles and, more particularly, to a spray nozzle a spray nozzle head rotatable on a spray nozzle base through articulated linkage.

2. Background

It is known to have a spray gun on an end of an extension pole for remote spraying of paint, stain, water and other fluids. In that configuration, fluid is regulated through the spray gun by remotely actuating its trigger. The spray gun may be rotated relative to the pole end to achieve a desired orientation of the spray gun. This configuration functions admirably but could be improved if the weight of a spray gun on the extension pole end could be eliminated while maintaining a wide range of rotation of the spray nozzle relative to the pole.

It is therefore an object of the present invention to provide an extension pole with a spray nozzle on its distal end. It is a further object that fluid spray through the spray nozzle be controlled from the extension pole proximal end. It is still another object that the spray nozzle on the pole distal end be oriented remotely from the pole proximal end through a wide range of rotation to a desired spray direction.

### SUMMARY

This is achieved in a spray nozzle mounted directly to an extension pole end in a swivel joint comprising a base connected to the pole, a head able to swivel relative to the base, and a manifold coupling the base to the head such that pressurized fluid passing through the pole passes into the base, through the manifold, into the head and then out of an orifice in the head, typically through a spray tip attached to the head at the orifice. The manifold provides a fluid conduit between the base and the head that allows the head to rotate while maintaining a fluid seal between the base and the head.

The base and the head each have a bore perpendicular to their axes aligned to receive the manifold therethrough. A bolt threads into the manifold base end compressing a first O-ring seal between the bolt head and a shoulder of an upper recess in the base. When the bolt and the manifold pull together as the bolt threads into the manifold, a shelf circumferential about the manifold on the base under side opposite the bolt head on the base upper side compresses a second O-ring seal between the shelf and a shoulder of a lower recess in the base. The degree of compression of the O-rings is thereby adjusted by the degree of tightening of the bolt into the manifold. The base has an axial passageway between a base entry orifice and the base bore that aligns with a manifold upper circumferential groove. A manifold upper passageway coplanar with the base passageway and radial to the manifold axis connects to a manifold axial passageway. Thus, the first and second O-rings effect a fluid seal between the base and the manifold passageways.

The manifold lower head portion below the shelf extends into the head bore perpendicular to the head axis, typically press fit together in a fluid seal, although any other similar connection is possible and deemed included in this disclosure, such as a threaded manifold lower portion engaging matching threads in the head bore. An axial head passageway connects between the head bore and a head discharge orifice similar to the base axial passageway. The head also has an axial passageway between a head discharge orifice and the head bore that aligns with the manifold lower circumferential groove. A manifold lower passageway coplanar with the head passageway and radial to the manifold axis connects to a manifold axial passageway. Thus, fluid communication is provided between the base entry orifice and the head discharge orifice while rotation of the head is enabled relative to the base, fluid communication continuing through the manifold circumferential grooves with the rotation. Thus configured the head rotates freely on the base a full 360 degrees.

Significantly, there is a fluid seal between the base and the manifold by way of the O-rings circumferentially around the manifold and between the manifold and the head, typically by way of the press fit, but not directly between the base and head. This allows the base and head to rotate without friction directly between them. It also allows the bolt to tighten the manifold and base together sufficiently to effect the fluid seal of the O-rings without regard to the head. The O-rings are also protected within the base as opposed to exposed between the base and the head.

To effect head rotation and to rotate and hold the head to a preferred orientation relative to the base, a lever is attached to the head, or equivalently, to the manifold firmly attached to the head. With the manifold firmly secured to the head, rotation of the manifold by movement of the lever also rotates the head relative to the base. The head rotates on the base with minimal friction to accommodate quick and facile remote adjustment of head orientation. However, the head in operation under high pressure discharge of fluid creates a torque on the head and pole that tends to move the head out of a preferred orientation. Thus, the lever connected through the rod to the adjustable actuator on the pole maintains the head properly oriented during operation in opposition to reaction forces derived from discharge of the high pressure fluid from the head.

Typically, the swivel nozzle is mounted on the distal end of an extension pole and used to spray fluid remotely. The configuration is useful, for example, in painting and pressure washing and any other situation where pressurized fluid could be delivered from a remote position or to a difficult to reach location. And then when the spray base is positioned in that location, it is oriented adjustably toward the spray target by movement of the lever.

To move the lever on the distal end of the extension pole, it is connected to a rod that runs between the lever and an actuator on the pole, typically intermediate the pole and within reach of the operator at the pole proximal end.

Typically, the actuator comprises a grip around the pole that slides along the pole when exercised by the operator. Therefore, any sliding movement of the handgrip on the pole causes rotation of the head on the base. Thus configured, the operator is able to support the pole with one hand on the grip as one would normally support an extension pole with one hand along the pole to stabilize and manipulate the pole while also using that bracing hand to control the nozzle orientation. The actuator may also comprise a

The lever is articulated with a first member pivotably connected to a second member intermediate the lever. With the first member connected to the rod and the second member connected to the base, as the actuator is moved between its position limits on the pole, the head moves through a range of motion of approximately 180 degrees, typically between approximately 30 degrees and 210 degrees where 0degrees is horizontal. Hereafter, the first or 30 degree position may be referred to as the first position and the second or 210 degree position may be referred to as the second position; the 90 degree position longitudinal with the pole may be referred to as the forward position, or forward; and the 270 degree which is directed to the pole proximal end may be referred to as the backward position, or backward.

The articulated lever comprises a forward member connected to the head and a rearward member pivotably connected to the rod and mutually connected to each other pivotably on a pivot pin intermediate the lever.

During use, with one hand on the actuator intermediate the pole, the operator's other hand is on a handgrip on the pole distal end that includes a trigger. Typically, a spray gun with a trigger is attached to the pole proximal end. Pulling the trigger opens pressurized fluid into and through the center of the pole and through a pole nozzle connector at the pole distal end to which the nozzle base is attached. Clearly, a conduit running along the outside of the pole between the nozzle connector and the pole connector is equivalent and is deemed included in this invention.

### BRIEF DESCRIPTION OF THE DRAWINGS

FIG. 1 is a cross-sectional view of the swivel nozzle of the present invention.

FIG. 2 is a side view of a swivel nozzle on the distal end of an extension pole with a rod connecting an articulated lever on the swivel nozzle to a sliding handgrip on the extension pole.

FIG. 3 is side view of the extension pole and swivel nozzle of FIG. 1 showing the spray nozzle in a first position as a counterclockwise limit of rotation.

FIG. 4 is side view of the extension pole and swivel nozzle of FIG. 1 showing the spray nozzle in a second position as a clockwise limit of rotation.

FIG. 5 is a side view the manifold that connects the base to the head with a bolt positioned to thread into the end of the manifold.

FIG. 6 is a planar view of the articulated lever.

FIG. 7 is a side view of the base with hidden lines showing internal structure.

FIG. 8 is a side view of the head with hidden lines showing internal structure.

FIG. 9 is a perspective view of the swivel nozzle and a forward member of the articulated lever shown with a pivot pin for pivotably connecting the forward member with a similar rearward member.

FIG. 10 is a side view of a swivel nozzle on the distal end of an extension pole with a rod connecting an articulated lever on the swivel nozzle to a rotating handgrip on the extension pole.

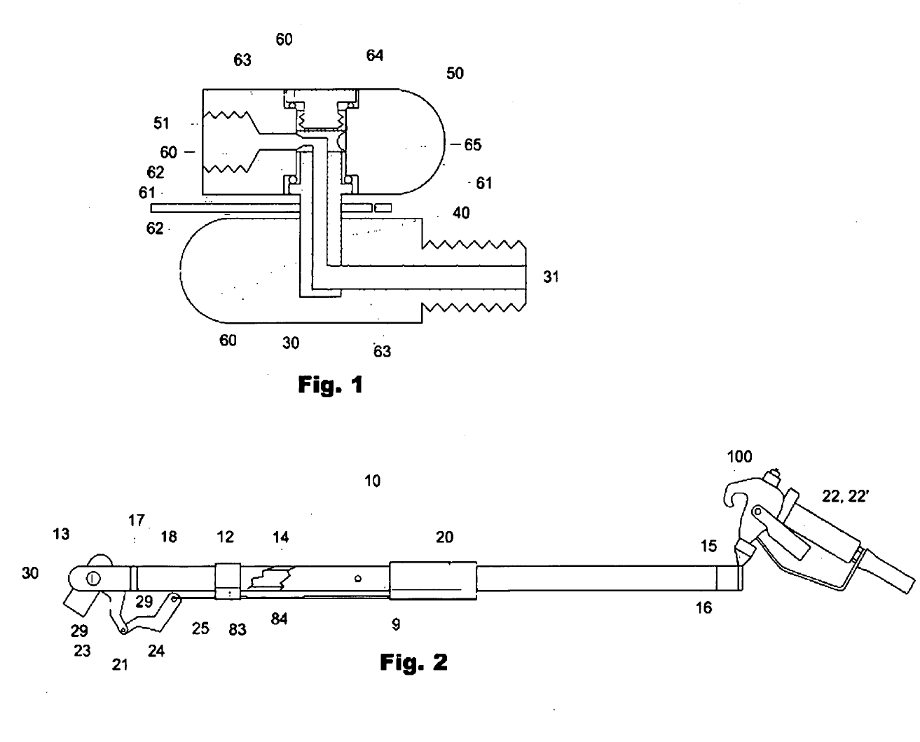

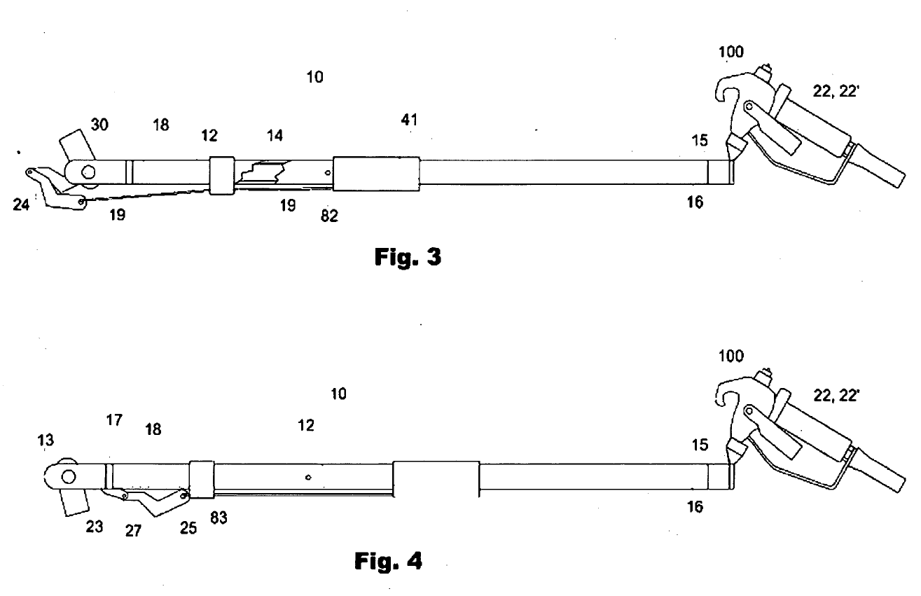

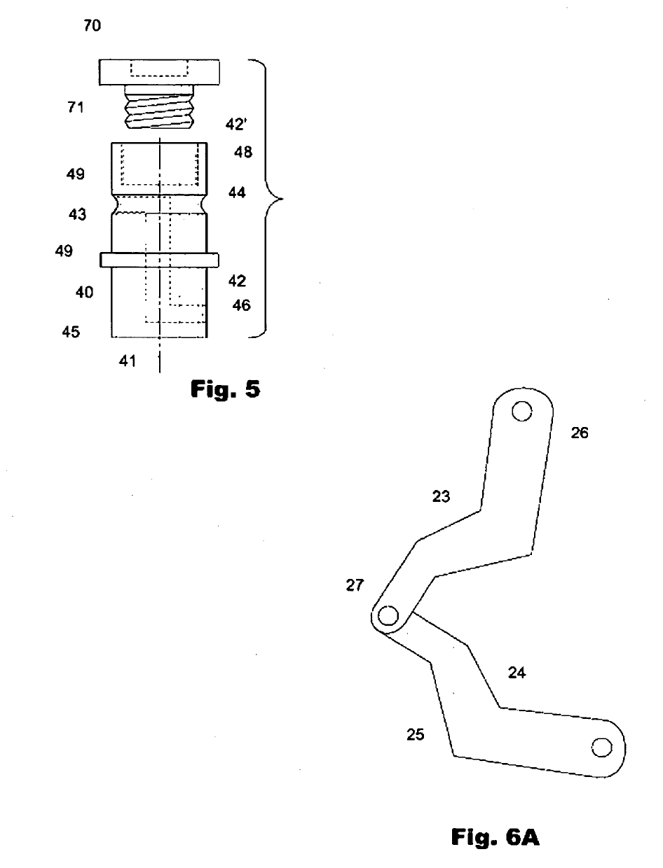

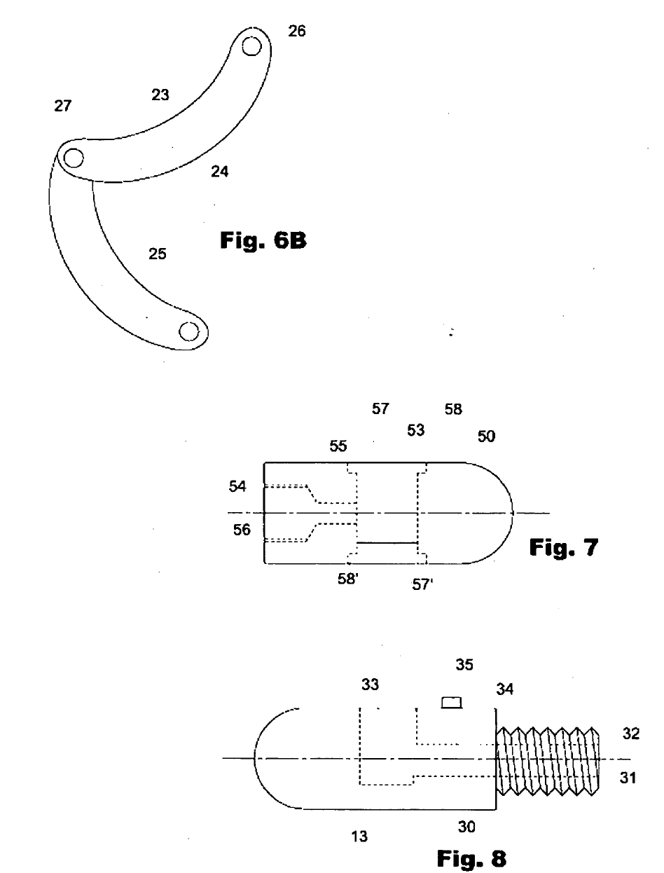

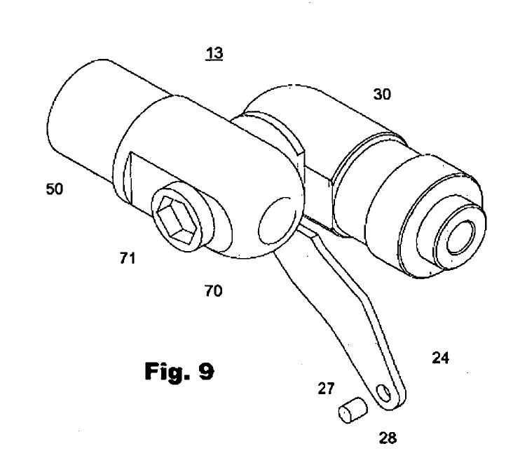

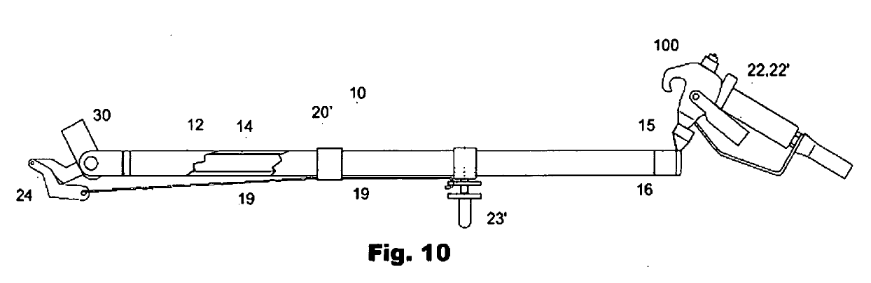

### DETAILED DESCRIPTION OF THE PREFERRED EMBODIMENTS

The portable remote swivel nozzle assembly 10 of the present invention incorporates adjustable orientation of a spray tip 11 for spraying pressurized fluids apart from an operator. It comprises an extension pole 12 through which fluid can pass and a swivel nozzle 13 that includes a swivel nozzle head 30. The pole 12 is tubular with a pole passageway 14 therethrough as a fluid conduit between a pole connector 15 on the pole proximal end 16 and the nozzle connector 17 on the pole distal end 18. A longitudinally incompressible rod 19 connects an actuator to the swivel nozzle head 30 through an articulated lever 24 to communicate movement of the actuator to the head 30 in adjusting orientation of the head 30 relative to the pole 12. Preferably the actuator comprises a handgrip 20 slidable on the extension pole 12 intermediate the pole 12. The hand grip includes a grip portion 9 adapted to receive a user's hand, the pole 12 slidably passing through the grip portion 9. Necessarily, the hand grip rearward, that is toward the pole proximal end, of a connection of the rod to the hand grip is without an obstruction extending therefrom that might impede said operator's hand from grasping the hand grip around the grip portion. Sliding of the handgrip 20 on the pole 12 changes orientation of the head 30 in a range of approximately 180 degrees relative to the pole 12 between a first position at 30 degrees and a second position at 210 degrees where 0 degrees is horizontal and 90 degrees is longitudinal with the pole away from the pole proximal end 16 and toward the pole distal end 18. The handgrip 20 also serves as a pole hold position that an operator uses to brace the pole 12 with a first hand while the operator's other hand operates a fluid-regulating trigger 22 on the pole proximal end operationally connected to regulate flow of pressurized fluid through the pole 12 to the nozzle connector 17. Typically, a spray gun 100 with a trigger 22 is attached to the extension pole proximal end 16. The trigger 22 then comprises a spray gun trigger 22′ that regulates flow from the spray gun 100 into the extension pole 12 and therefore through the swivel nozzle 13 to the spray tip 11.

Though the sliding handgrip 20 is the preferred embodiment, any other mechanism on the pole 12 that serves to adjust the head orientation is deemed equivalent and included in the invention. For example, as a second embodiment, a pole arm as a handle grip 20′ also mounted at a fixed position on the pole 12 rotates on an axis transverse to the pole in the manner of a motorcycle handle grip and also mechanically connects to the head 30 through the rod 19 such that rotation of the handle grip 20′ causes the head to rotate.

To facilitate rotational movement of the head 30, a lever 24 is attached to the head 30 extending outward therefrom to which the rod 19 is attached therein connecting the handgrip 20 to the head 30. The lever 24 may be adjusted in its attachment to the head 30 to achieve a different range of head movement. The head ranges between limits of movement when the handgrip 20 is fully extended and when the handgrip 20 is fully withdrawn. Typically, those limits of movement, or rotation, are between the first and second positions given above. To achieve that range of movement, the lever 24 is articulated. A lever forward member 23 attaches to the swivel head 30 and a lever rearward member 25 attaches to the rod 19. The two members 23, 26 mutually)attach pivotably on a pivot pin 27 passing through aligned holes 28 in the two members pivot ends 21.

The lever rearward member 25 of the articulated lever 24 is curved in effective C-shape with its concave portion opening toward the pole 12 such that when the rod 19 is pushed to its most forward position the rearward member 25 reaches from the rod 19 to the forward member 23 over the distal end 18 of the pole 12 urging the forward member 23 and spray nozzle head 30 connected thereto to rotate in a first rotation direction to a first position.

Equivalent to a C-shape curve in the rearward member 25, the rearward member 25 may comprise a dog-leg shape, or change in direction, roughly following a C-shape. With the nozzle head 30 directed forward (90 degrees or parallel with the pole), the lever forward member 23 extends away from its connection with the head 30 and then forward through the dog-leg 29, turning more outward, or more away from the pole 12 and swivel nozzle head 30, to its pivot end. The lever rearward member 25 extends away from its pivot connection with the rod 19 and then forward also through a dog-leg 29 turning more outward to its pivot end 21, partially side by side with the forward member 23.

The curved lever rearward member, or equivalent a dog-leg, 29 and the articulation in the forward and rearward members 23, 26 produce a force with a horizontal component when the pivot pin 27 connecting them is aligned with the rod 19 beyond the pole distal end 16 where rotation would stop if the rod 19 were connected to a straight, non-articulated lever, equivalent to connecting the rod to the forward member 23 at its pivot end 21. The horizontal force thus causes the nozzle head 30 to continue to rotate “counterclockwise” to its first position. Without the curved rearward member or dog-leg 29 and articulation with the lever forward member, the head rotation might be limited to near forward, but with the curved rearward member or dog-leg 29 the lever 24 effects a further head rotation as the rearward member 25 shifts slightly outward from the rod 19 away from the pole 12 upon further pushing by the rod 19, pushing the pivot pin 27 across 90 degrees and beyond to the first position at 30 degrees.

As described, the nozzle head 30 is configured to swing between about 30 degrees and about 300 degrees. However, it should be recognized that these are arbitrary limits selected for convenience of description and representative of a typical configuration for use. Other limits could as easily be selected equivalently. All ranges of rotation of the swivel head 30 are deemed included in this invention and the description given is to be construed as representative of all possible ranges of rotation. It is also recognized that the nozzle head 30 could be rotationally positioned relative to the forward member 23, emphasizing that the illustrative ranges are dependent also on the relative positions of the nozzle and the lever forward member 23. For example, the range could easily be changed by −90 degrees simply by mounting the forward member 23 on the spray nozzle head 30 rotated by that amount, in which case the range of motion would be −60 degrees to 210 degrees without changing the lever configuration or the limits of movement of the articulated lever 24, which if changed would also change the range of rotation of the nozzle head 30. Therefore, the first position, given as 30 degrees for illustration, as applied herein, including the claims, shall mean a most counterclockwise limit of rotation and the second position, given as 300 degrees for illustration, as applied herein shall mean a most clockwise limit of rotation and not only the numerical position given.

With the nozzle head 30 in its second position, or about 270 degrees, the forward and rearward members 23 and 26 spread apart on the pivot pin 27 with the pivot pin 27 just short of alignment with the rod 19, if it were extended, stopping short of alignment to prevent the articulated lever 24 from binding when the rod 19 pushes on the lever 24.

As a limit on forward movement of the handgrip, a stop pin 82 extends from the pole 12 that prevents the sliding handgrip 20 from moving more forward on the pole 12 past the stop pin position. The stop pin 82 is positioned on the pole 12 such that the articulated lever 24 rotates the head 30 to a first position of about 30 degrees and no further, so when the handgrip 20 is withdrawn toward the pole distal end 18, the linkage does not bind but pulls smoothly in rotating the head “clockwise” with the head moving through full forward (90 degrees) and through full outward (270 degrees) to a second position (about 300 degrees) representing an opposite rotation limit with the pivot pin 27 nearly aligned with the rod 19.

A rearward movement stop 83 on the pole limits rearward movement of the rod 19 and handgrip 20. Typically, the rearward member 25 or a rod distal end 84 impacts the rearward movement stop 83 as a movement limit on rearward longitudinal movement. The rearward movement stop 83 is located on the pole 12 such that the rod 19 cannot withdraw rearward to a position where the pivot pin 27 of the lever 24 aligns with the rod 19. Thus, the articulated lever 24 does not bind with subsequent forward movement of the slidable handgrip 20. The rearward movement stop 83 also functions to support and guide the rod 19 near the pole distal end 18. It is noted that although impact of the rearward member 25 or the rod distal end 84 is the preferred alternative, in an alternate embodiment the rearward movement stop 83 is located low on the pole 12, approaching the pole proximal end 16, where the handgrip 20 impacts it when the nozzle head 30 is in its second position.

The swivel nozzle 13 further comprises a manifold 40 swivelly connecting the swivel nozzle head 30 to a swivel nozzle base 50 with fluid seals 60 between the manifold 40 and the head 30 and between the manifold 40 and the base 50 to prevent leaks. The head 30 is spaced apart from the base 50 on the manifold 40 with a continuous air gap 61 between all base and head opposing surfaces 62 to eliminate frictional engagement between them to enable ease of rotation of the head 30 relative to the base 50. Where the head 30 rotates on the base 50 with minimal friction to accommodate quick and facile remote adjustment of head orientation, the lever 24 also serves to maintain the head 30 properly oriented during high-pressure fluid discharge from the head 30.

A base connector 51, which is typically a threaded hole matching a threading rod in the pole nozzle connector (not shown) in the swivel nozzle base 50 removably attaches to the nozzle connector 17. Typically the base 50 swivels on the manifold 40 and the head 30 is rigidly attached to the manifold 40. The lever, 24 is firmly connected to the manifold 40, the manifold 40 passing through lever hole 26, thus also firmly connecting the lever 24 to the head 30. Connecting passageways 63 in the base, manifold and head provide continuous fluid communication between the base connector 51 and a discharge orifice 31 in the head 30 through which fluid is provided to the spray tip 11 attached to the head 30. Upper and lower O-rings 64 and 65 spaced apart around the manifold 40 between the manifold 40 and the base 50 provide the required fluid seal.

The base 50 has a base bore 53 perpendicular to a base axis 54 running longitudinally with the base 50 into which the manifold 40 swivelly fits. A base passageway 55 connects between the base bore 53 and a base entry orifice 56 at the base connector 51.

The manifold 40 has an axis 41 that runs longitudinally with the manifold 40 and a manifold axial passageway 42 axially through the manifold 40. A manifold upper passageway 43 runs radially from the manifold axis 41 between the manifold axial passageway 42 and the base passageway 55. A manifold upper circumferential groove 44 intersects the manifold upper passageway 43 between the upper and lower O-rings 64 and 65 coplanar with the base passageway 55 therein providing fluid communication between the base entry orifice 56 through the base passageway 55 to the manifold upper circumferential groove 44 and then to the manifold axial passageway 42. Thus, the O-rings 64 and 65 establishing a fluid seal between the base 50 and the manifold 40 such that fluid from the base entry orifice 56 flows only into the manifold axial passageway 42 and the head 30 is adjustable through a full 360-degree revolution relative to the base 50.

Similarly, the head 30 has a head axis 32 that runs longitudinally with the head 30 and a head bore 33 perpendicular to the head axis 32 receiving a portion 45 of the manifold 40. Preferably, the manifold 40 is integrated into the head 30 by a press fit into the head bore 33, precluding movement of the head 30 on the manifold 40 and inherently providing the required fluid seal 60 between manifold 40 and the head 30. A head passageway 34 runs between the head bore 33 and the head discharge orifice 31. The manifold 40 also has a manifold lower passageway 46 radial from the manifold axis 41 in fluid communication with the head passageway 34, the manifold 40 thus providing fluid connection between the base connector 51 in the base 50 and the discharge orifice 31 in the head 30.

The manifold 40 is secured in base bore 53 by a bolt 70 with a bolt head 71 threaded into matching threads in the manifold axial passageway 42 at its head end 48. Equivalently, the manifold may have a partition 49 that separates the axial passageway 42 from a threaded bolt hole 42′ in the manifold head end 48.

The base 50 further includes upper and lower recesses 57 and 57′ opening upward and downward, respectively, outward from the base 50 that form upper and lower shoulders 58 and 58′ around the base bore 53. The upper and lower O-rings 64 and 65 are located on the upper and lower shoulders 58 and 58′, respectively. The manifold 40 also includes an annular shelf 49 circumferential about the manifold 40 and intermediate its length. Thus, as the bolt 70 tightens into the manifold 40 pulling the manifold shelf 49 and the bolt head 71 together from opposite sides of the base 50, the upper O-ring 64 is compressed between the bolt head 71 and the upper shoulder 58 and the lower O-ring 65 is compressed between the annular shelf 49 and the lower shoulder 58′. The O-rings 64 and 65, and especially, the lower O-ring 64, is thus housed within the swivel nozzle 13 in the base bore 53 to protect them from damage during use. Preferably, the lower recess 57′ and annular shelf 49 is sized such that the shelf 49, and thus the lower O-ring 65, also fits inside the lower recess 57′ when the bolt 70 is tightened to maintain continuous, unobstructed opposing surfaces between the head 30 and base 50.

What is claimed is:

1. A portable remote swivel nozzle assembly with adjustable spray orientation for spraying pressurized fluids, comprising:
a portable extension pole with a proximal end and a distal end,
a swivel nozzle including a base connected to the pole distal end at a swivel nozzle base connector and a head swivelly connected to the base, the swivel nozzle having a through passageway between the pole distal end and a discharge orifice in the head,
an articulated lever comprising a forward member firmly connected to the swivel nozzle head and a rearward member pivotably connected to the forward member on a pivot pin,
an actuator on the extension pole,
a longitudinally incompressible rod attached between the lever rearward member and the actuator such that movement of the actuator on the extension pole causes the lever members to pivot and rotate the nozzle head relative to the base.

2. The portable remote swivel nozzle assembly of claim 1 wherein the actuator comprises a hand grip slidable on the pole causing the head to rotate relative to the base as the hand grip slides on the pole, the hand grip further comprising a grip portion adapted to receive a user's hand, the pole slidably passing through the grip portion.

3. The portable remote swivel nozzle assembly of claim 1 wherein the actuator comprises a pole arm as a handle grip mounted at a fixed position on the pole, the handle grip rotating on an axis transverse to the pole in the manner of a motorcycle handle grip and mechanically connected to the head through the rod such that rotation of the handle grip causes the head to rotate.

4. The portable remote swivel nozzle assembly of claim 1 wherein the rearward member of the articulated lever is curved in effective C-shape with its concave portion opening toward the pole such that when the rod is pushed to its most forward position the rearward member reaches from the rod to the forward member over the distal end of the pole urging the forward member and spray nozzle head connected thereto to rotate in a first rotation direction to a first position.

5. The portable remote swivel nozzle assembly of claim 4 wherein the pivot pin connecting the forward and rearward members moves from a rod pole side fully over the distal end of the pole away from that rod pole side when the nozzle head is pushed to a first position.

6. The portable remote swivel nozzle assembly of claim 5 wherein when the rod is withdrawn toward the pole proximal end to a most rearward position the rearward member pulls the forward member causing the nozzle head to rotate opposite the first rotation to a second position.

7. The portable remote swivel nozzle assembly of claim 6 wherein rotation between said first and second positions constitute a range of rotation between approximately 30 degrees and 300 degrees where 0 degrees is horizontal or transverse to the pole and 90 degrees is longitudinal with the pole away from the pole proximal end and toward the pole distal end.

8. The portable remote swivel nozzle assembly of claim 7 wherein the range motion can be shifted by a given rotational amount by rotating the mounting of the nozzle head relative to the lever forward member by said given rotational amount.

9. The portable remote swivel nozzle assembly of claim 8 wherein said given rotational amount is 90 degrees resulting in a range of motion of −60 degrees to 240 degrees.

10. The portable remote swivel nozzle assembly of claim 6 further comprising a rearward movement stop on the pole preventing further rearward movement of the handgrip and lever when the spray nozzle is at the second position.

11. The portable remote swivel nozzle assembly of claim 5 further comprising a stop pin on the pole preventing further forward movement of the handgrip and lever when the spray nozzle is at the first position.

12. A portable remote swivel nozzle assembly with adjustable spray orientation for spraying pressurized fluids, comprising:
a portable extension pole with a proximal end and a distal end,
a swivel nozzle including a base connected to the pole distal end at a swivel nozzle base connector and a head swivelly connected to the base, the swivel nozzle having a through passageway between the pole distal end and a discharge orifice in the head,
an articulated lever comprising a forward member firmly connected to the swivel nozzle head and a rearward member pivotably connected to the forward member on a pivot pin,
a hand grip slidable on the pole causing the head to rotate relative to the base as the hand grip slides on the pole, the hand grip further comprising a grip portion adapted to receive a user's hand, the pole slidably passing through the grip portion,
a longitudinally incompressible rod attached between the lever rearward member and the handgrip such that sliding movement of the handgrip on the extension pole causes the lever members to pivot and rotate the nozzle head relative to the base,
wherein the rearward member of the articulated lever is curved in effective C-shape with its concave portion opening toward the pole such that when the rod is pushed to its most forward position the rearward member reaches from the rod to the forward member over the distal end of the pole urging the forward member and spray nozzle head connected thereto to rotate in a first rotation direction to a first position, the pivot pin connecting the forward and rearward members moving from a rod pole side fully over the distal end of the pole away from that rod pole side when the nozzle head is pushed to its first position, and
wherein when the rod is withdrawn toward the pole proximal end to its most rearward position the rearward member pulls the forward member causing the nozzle head to rotate opposite the first rotation to a second position,
a rearward movement stop on the pole preventing further rearward movement of the handgrip and lever when the spray nozzle is at the second position,
a stop pin on the pole preventing further forward movement of the handgrip and lever when the spray nozzle is at the first position.
